(19) United States
(12) Patent Application Publication
(10) Pub. No.: US 2002/0083237 A1
(43) Pub. Date: Jun. 27, 2002

(54) Silicon components in computer system isolation circuits

(76) Inventors: James A. Howell JR., Georgetown, TX (US); James H. Leftwich, Austin, TX (US)

Correspondence Address: Stephen A. Terrile, SKJERVEN MORRILL MacPHERSON LLP, Suite 700, 25 Metro Drive, San Jose, CA, 95110-1349, US

(21) Appl. No.: 09/746,313

(22) Filed: Dec. 22, 2000

(51) Int. Cl. G06F 13/00

(52) U.S. Cl. 710/62

(57) ABSTRACT

The present invention incorporates a silicon based isolation device into a portable computer. An additional silicon based isolation device is also incorporated into a docking station for a personal computer. Either or both of the isolation components may be programmable. The invention also teaches a silicon based isolation device for use with a modem. Again, the silicon based isolation devices may be programmable. An embodiment of the invention teaches a circuit (or other means) to detect docking of the computer in a docking station.

### BACKGROUND OF THE INVENTION

1. Field of the Invention

The present invention relates to utilizing silicon components to isolate a portable computer from a telephone system.

2. Description of the Related Art

Computer systems are electronic information handling systems which can be designed to give independent computing power to one user or a plurality of users. Computer systems in general, and personal computer systems in particular, have attained widespread use within many segments of today's society. A personal computer system can usually be defined as a desktop, floor standing, or portable microcomputer that includes a system processor, memory, a display monitor, a keyboard, one or more diskette drives and a fixed disk storage device.

A personal computer may also include one or a plurality of peripheral devices which are coupled to the system processor and which perform specialized functions. Examples of peripheral devices include modems, sound and video devices or specialized communication devices. Mass storage devices such as hard disks, CD-ROM drives and magneto-optical drives are also considered to be peripheral devices.

Computer systems include desktops and portable systems. Portable computer systems may include a docking station to facilitate use of the computer at a certain location, typically in the user's home. A docking station allows a portable computer to be operated as a desktop computer and provides a larger keyboard and a larger monitor or display. The larger keyboard and monitor remain coupled to the docking station when the laptop is removed eliminating the need for the user to disconnect and reconnect each device whenever removing the portable from the docking station. In addition, a docking station also includes a power supply to provide power to the portable computer.

Typically, a portable computer (also called a laptop) includes a modem which allows connection to the internet and other communications media when the computer is operated in a stand-alone mode. Utilizing the telephone connection in the body of the laptop requires a user to disconnect and reconnect the telephone line each time the laptop is moved to a new location. The telephone connection at the docking station remains when the portable computer is removed and is immediately available when the portable computer is inserted. The user need not make an additional telephone connection after inserting the portable computer in the dock.

Telephone systems conform to various standards throughout the world. For example, connections to the telephone system in the United States conform to specifications promulgated by the Federal Communications Commission (FCC). In Japan, a similar regulatory body (JATE) promulgates communications standards. Due to the difference in standards a portable computer capable of communicating with the telephone system in one country, may not be capable of communicating with the telephone system in another location.

Telephone circuit voltages may be as high as 50 volts, but computer system voltages are much lower. References describe use of direct access arrangements (DAAs) to isolate the higher telephone voltages from the lower voltage computer circuits to prevent damage to the computer in the event of a voltage surge. U.S. Pat. No. 5,931,929 to Tran, describes a portable computer with modem and docking station. U.S. Pat. No. 6,044,422 a continuation of the '929 patent, discloses and claims a modem with an isolation circuit to protect a portable computer from high voltages from the telephone connection. Neither the '929 patent nor '422 patent disclose nor claim a circuit or other means to detect when the portable computer is inserted in the docking station.

Due to the differences in international standards, a portable computer used in one location or country, may not function in a country with an incompatible standard. Neither the '929 patent nor the '422 patent discloses or claims a programmable isolation device. A programmable silicon based isolation device would allow a user to operate his or her laptop as a stand alone in one country and inserted in a docking station in a country with an otherwise incompatible communication standard.

### SUMMARY OF THE INVENTION

The present invention incorporates a silicon based isolation device into a portable computer. An additional silicon based isolation device is also incorporated into a docking station for a personal computer. Either or both of the isolation components may be programmable. The invention also teaches a silicon based isolation device for use with a modem. Again, the silicon based isolation devices may be programmable. An embodiment of the invention teaches a circuit (or other means) to detect docking of the computer in a docking station.

The foregoing is a summary and this contains, by necessity, simplifications, generalizations and omissions of detail; consequently, those skilled in the art will appreciate that the summary is illustrative only and is not intended to be in any way limiting.

### BRIEF DESCRIPTION OF THE DRAWINGS

The present invention may be better understood, and its numerous objects, features, and advantages made apparent to those skilled in the art by referencing the accompanying drawings.

FIG. 1 shows the physical arrangement of a laptop computer, keyboard, printer and docking station.

FIG. 2 shows the interconnection between a laptop and the docking station.

FIG. 3 shows the related art.

FIG. 4 shows the invention, incorporating a silicon isolation device in place of the isolation device as shown in FIG. 3.

FIG. 5 shows an embodiment of the invention including a circuit to detect docking of the laptop computer in the docking station.

The use of the same reference symbols in different drawings indicates similar or identical items.

### DETAILED DESCRIPTION OF THE DRAWINGS

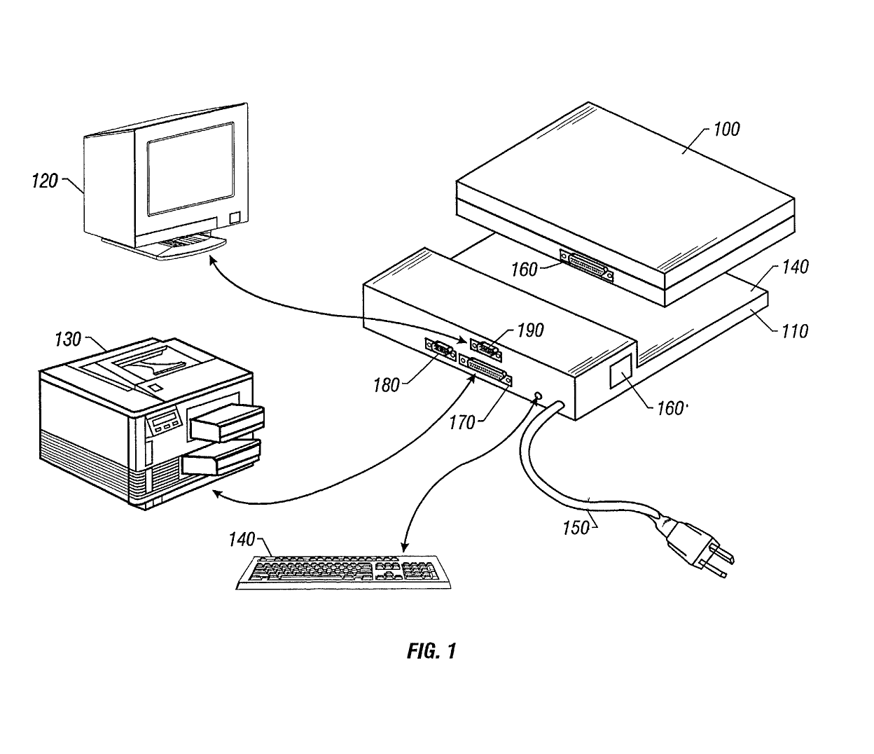

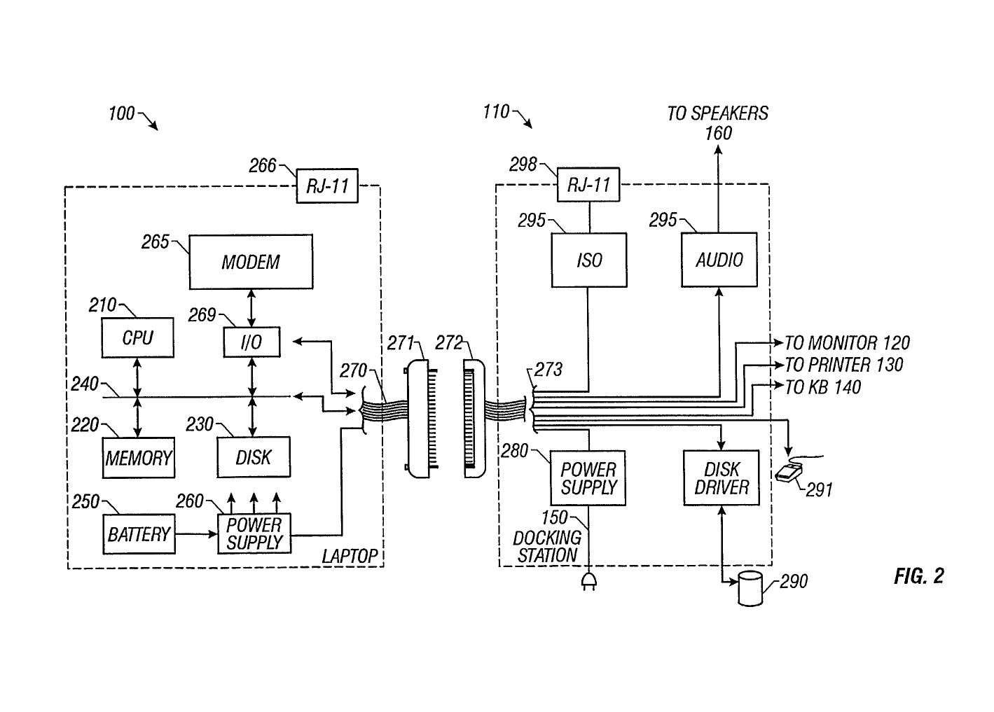

Referring to FIG. 1, computer 100 is shown along with docking station 110, monitor 120, printer 130 and keyboard 140. Computer 100 can be operated in a stand-alone mode, but may be coupled to docking station 110. Docking station 110 includes recess 140 to receive computer 100. Computer 100 can be battery-operated while apart from docking station 110, and can be powered from supply 150 when docked. Typically, docking station 110 also includes speakers 160, printer connection 170, data connection 180 and monitor connection 190. The docking station can also support attachments to other accessories including a mouse, as shown in FIG. 2 and a microphone and joystick (not shown). Memory resources, including disk drives and a CD-ROM drive may also be included in the docking station as shown in FIG. 2.

FIG. 2 shows the components of the laptop computer 100 and the connection between those components and docking station 110. CPU 210 is connected to main memory 220 and a disk storage unit 230 by system bus 240. The laptop is powered by a battery 250 and a power supply circuit 260. Modem 265 is also accessed by the CPU via the system bus 240 and I/O bus 269. Modem 265 connects to the telephone system (not shown) through connector 266. Connection to the elements of docking station 110 is by multiconductor 270 which conveys both logic voltages and power supply voltages to and from the docking station.

FIG. 2 also shows the components and internal connections of docking station 110, as previously shown on FIG. 1. Connection between the laptop and docking station is facilitated by multi-pin connector 271 mating to multi-pin connector 272. Multi-pin connector 272 connects to individual components of docking station 110 through multi-connector 273. Multiconductor 273 also connects to the monitor 120, printer 130, keyboard 140 and speakers 160 as shown previously in FIG. 1. Multiconductor 273 connects to power supply 280 which is coupled to power multiconductor 150, as shown previously in FIG. 1. Multiconnector 273 transmits logic signals to and from disk drive 290 and mouse 291.

Multiconductor 273 also connects to isolation device 295 which is coupled to connector 298 which can be coupled to the telephone system, not shown. The telephone line contains two wires called tip and ring. These two wires carry the incoming and outgoing analog telephone signals, the ring signal, and the power which operates the telephone set itself in some traditional phone installations. The voltages occurring on the telephone line are ordinarily up to 50 Volts, transient voltages may be even higher. Many computers currently being manufactured operate at 12 Volts or less. Connecting a relatively low voltage computer to a higher voltage telephone line introduces the possibility of damage to the computer from the proximity of the higher operating voltages. Connecting connector 298 to isolation device 295 reduces the possibility of damage to the computer caused by the proximity of higher voltage telephone lines.

The telephone line remains connected to docking station 110 when computer 100 is removed. Thus, the user can establish a connection with the telephone system merely by inserting computer 100 into docking station 110. Separately connecting a telephone line to docking station 110 is not necessary.

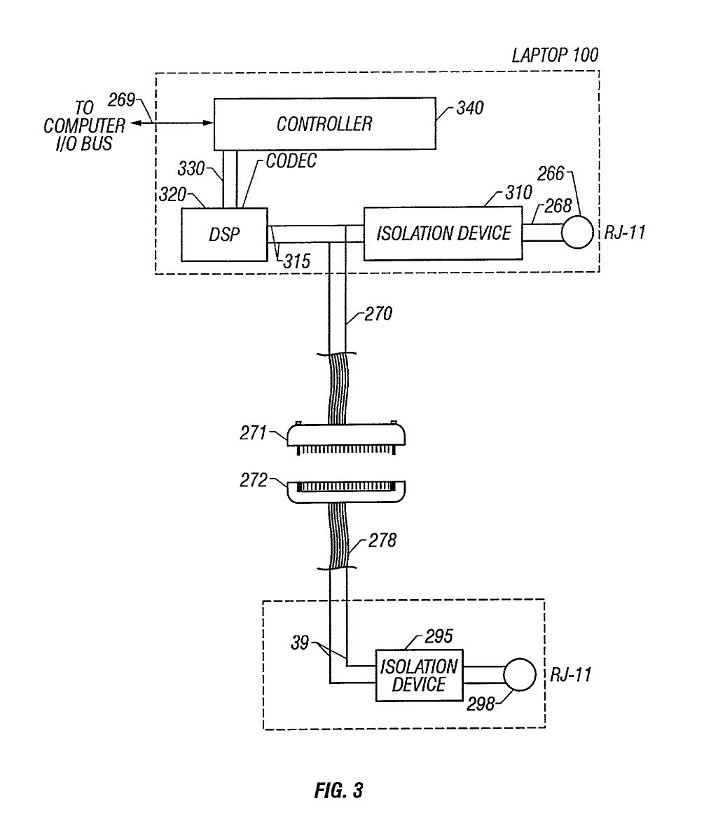

FIG. 3 shows the configuration of computer 100 when computer 100 is operated as a stand alone. From telephone jack 266, (previously shown on FIG. 2) two lines 268 are coupled to isolation device 310, also referred to as an isolation component. Isolation device 310 is coupled to digital signal processor 320 and multiconductor 270 through conductors 315. Digital signal processor 320 is used for analog-to-digital and digital-to-analog conversions and for filtering functions, decoding and encoding data, signal detection and sending and receiving data from the computer system via lines 330 from modem controller 340. From modem controller 340 the signal is communicated directly to the computer I/O bus 269, shown previously on FIG. 2.

FIG. 3 also shows the connection between the laptop and docking station. Multiconductor 270 is connected to multi-pin connector 271 which mates with multi-pin connector 272. Multi-pin connector 272 is connected to multiconductor 273 which is coupled to isolation device 295 (shown previously) and telephone connector 298, also shown previously in FIG. 2.

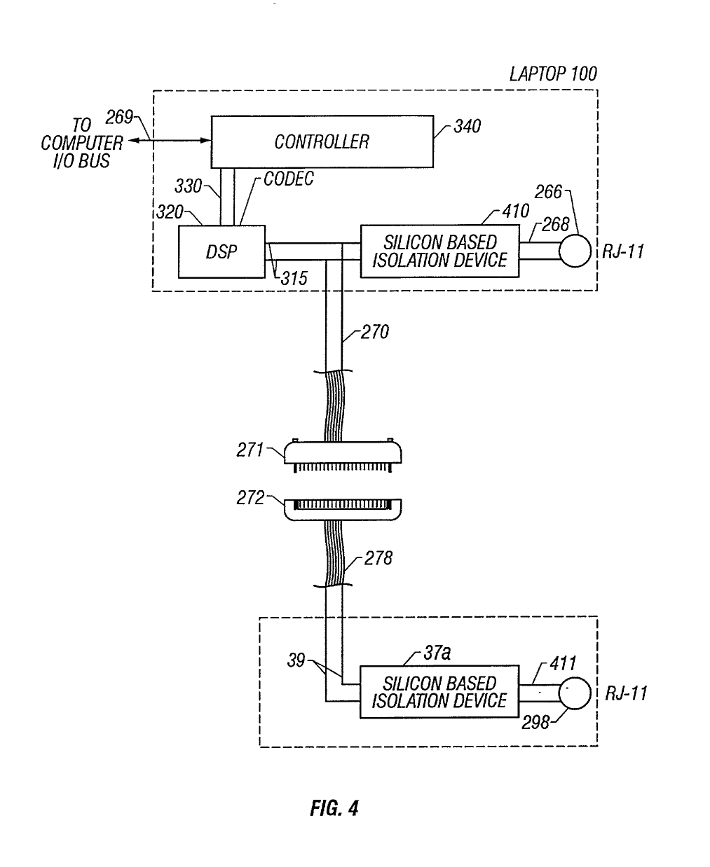

FIG. 4 illustrates the invention utilizing a silicon based isolation component 410. Silicon based isolation component 410 is connected via lines 315 to digital signal processor 320. Digital signal processor 320 is coupled to modem controller 340 through conductors 330 as previously shown in FIG. 3. Modem controller 340 is connected directly to the computer I/O bus 269. Thus, when laptop 100 is operated as a stand alone, communications with the telephone system is through silicon isolation component 410 and phone jack 266. However, when nested in the docking station 110, connection to the telephone system is through phone jack 298 and silicon isolation component 411. Silicon based isolation component 411 connects to conductors 315 through mating multi-pin connectors 271 and 272 and multiconductor 278. Examples of silicon based isolation devices are available from Silicon Laboratories as part numbers Si3036 and Si3038. Further information including specification and drawings may be obtained from Silicon Labs website located at www.silabs.com.

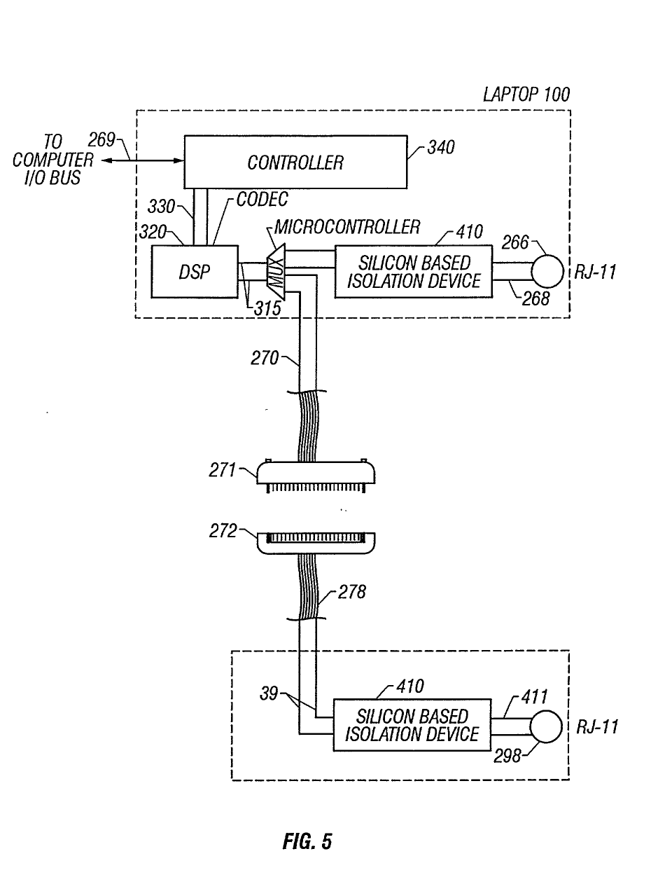

An embodiment of the invention includes a circuit, or other device, to detect when the laptop is docked. The feature is depicted in FIG. 5. Multiconductor 270 from the laptop computer mates with multi-pin connector 271 which mates with multi-pin connector 272 which in turn couples to conductor 278 within the docking station. Multiconductors 270 and 278 are low-voltage, containing all of the logic-level voltages and supply voltages at levels used for computer functions. Inserting the portable computer into the docking station generates a signal which is transmitted to the portable computer by multiconductor 278 through multi-pin connectors 271 and 272 to multiconductor 270 to controller 430 (not previously shown)from the docking station.

According to user preferences, after docking the portable computer, either programmable isolation component may be utilized. A user may elect to utilize the isolation device in the computer even when docked if the protocol of the isolation device in the docking station is not compatible with the local telephone system. When the user has not programmed a preference, the isolation component in the docking station will be used.

While particular embodiments of the present invention have been shown and described, it will be recognized to those skilled in the art that, based upon the teachings herein, further changes and modifications may be made without departing from this invention and its broader aspects, and thus, the appended claims are to encompass within their scope all such changes and modifications as are within the true spirit and scope of this invention.

What is claimed is:

1. A computer system, comprising:
a portable computer having a housing, a modem located within the housing and a first isolation component coupled to the modem wherein the first isolation component is a silicon based component.

2. A computer system, comprising:
a portable computer having a housing, a modem located within the housing, and a first isolation component coupled to the modem wherein the first isolation component is programmable.

3. The computer system as recited in claim 2, further comprising:
a second isolation component, wherein the second isolation component is a silicon based component, wherein the second isolation component is coupled to the first isolation component.

4. The computer system as recited in claim 3, wherein the second isolation component is programmable.

5. The computer system as recited in claim 4, further comprising:
a docking station, wherein the portable computer is removably coupled to the docking station, wherein the second isolation component is located within the docking station.

6. The computer system as recited in claim 5, further comprising:
a circuit wherein the circuit detects docking of the portable computer in the docking station and sends a signal to the computer when the computer is coupled to the docking station.

7. The computer system as recited in claim 5, further comprising:
means for detecting docking of the portable computer in the docking station.

8. A modem for a computer system, comprising:
a first isolation component, wherein the first isolation component is silicon based.

9. The modem for a computer system as recited in claim 8, wherein the first isolation component is programmable.

10. The modem for the computer system as recited in claim 8, further comprising a second isolation component, wherein the second isolation component is coupled to the first isolation component, wherein the second isolation component is silicon based.

11. The modem for the computer system as recited in claim 10, wherein the second isolation component is programmable.

12. An improved computer system, wherein the improvement comprises:
a first isolation component wherein the first isolation component is silicon based.

13. The improved computer system as recited in claim 12, wherein the first isolation component is programmable.

14. The improved computer system as recited in claim 12, further comprising:
a second isolation component, wherein the second isolation component is coupled to the first isolation component, wherein the second isolation component is silicon based.

15. The improved computer system as recited in claim 14, wherein the second isolation component is programmable.

16. An improved modem, wherein the improvement comprises:
a first isolation component, wherein the first isolation component is silicon based.

17. The improved modem as recited in claim 16, wherein the first isolation component is programmable.

18. The improved modem as recited in claim 16, further comprising:
a second isolation component, wherein the second isolation component is silicon based, wherein the second isolation component is coupled to the first isolation component.

19. The improved modem as recited in claim 16, wherein the second isolation component is programmable.

20. A method of operating a computer system, comprising:
operating a portable computer in a first country wherein the portable computer is coupled to the telephone line by a first isolation component, wherein the first isolation component is programmable, wherein the first isolation component is located within the computer housing;
transporting the portable computer to a second location, the telephone system in the second location not directly compatible with the telephone system in the first location; and
coupling the portable computer to a docking station, wherein the docking station further comprises a second isolation component, wherein the second isolation component is programmable and allows operation of the portable computer with the telephone system of the second location.
